(19) United States
(12) Patent Application Publication
(10) Pub. No.: US 2010/0112891 A1
(43) Pub. Date: May 6, 2010

(54) METHOD OF MANUFACTURING PLASMA DISPLAY PANEL

(76) Inventors: Shinichiro Ishino, Osaka (JP); Kaname Mizokami, Kyoto (JP); Koyo Sakamoto, Osaka (JP); Akira Shiokawa, Osaka (JP); Hiroyuki Kado, Osaka (JP); Yoshinao Ooe, Kyoto (JP); Hideji Kawarazaki, Osaka (JP); Kazuo Uetani, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/595,681

(22) PCT Filed: Mar. 10, 2009
(86) PCT No.: PCT/JP2009/001053

§ 371 Date: Oct. 13, 2009

(30) Foreign Application Priority Data
Mar. 12, 2008 (JP) 2008 062160

(51) Int. Cl. H01J 17/49

(52) U.S. Cl. 445/58

(57) ABSTRACT

In the method of producing a PDP, the protective layer is produced in the following steps. First, deposit a base film on the dielectric layer, and then apply a crystalline particle paste produced by dispersing plural crystalline particles made of metal oxide, onto the base film to form a crystalline particle paste film. After that, fire the base film and crystalline particle paste film to make the plural crystalline particles adhere so as to be distributed over the whole surface. The crystalline particle paste has a viscosity between 1 Pa·s and 30 Pa·s inclusive at a shear velocity of 1.0 s⁻¹.

### TECHNICAL FIELD

The present invention relates to a method of manufacturing plasma display panels used for such as a display device.

### BACKGROUND ART

Plasma display panels (referred to as a PDP hereinafter) capable of moving to finer-resolution and of increasing the screen size are commercialized such as for a 65-inch-class television set. In recent years, a PDP has been applied to high-definition TV with the number of scanning lines twice that of conventional NTSC method, while a demand for lead-free PDPs has been made with consideration for environmental issues.

A PDP is basically composed of a front panel and a back panel. The front panel is composed of a glass substrate made of sodium borosilicate glass produced by float process; display electrodes composed of striped transparent electrodes and bus electrodes formed on one main surface of the glass substrate; a dielectric layer covering the display electrodes to function as a capacitor; and a protective layer made of magnesium oxide (MgO) formed on the dielectric layer. Meanwhile, the back panel is composed of a glass substrate; striped address electrodes formed on one main surface of the glass substrate; a base dielectric layer covering the address electrodes; barrier ribs formed on the base dielectric layer; and phosphor layers formed between each barrier rib, each phosphor layer emitting light in red, green, and blue.

The front panel and back panel are hermetic-sealed with their electrode-formed surfaces facing each other, and an Ne—Xe discharge gas is filled in discharge spaces partitioned by barrier ribs at a pressure of 400 to 600 Torr. A PDP implements color image display (refer to patent literature 1) by applying a video signal voltage to a display electrode selectively to cause discharge, which generates ultraviolet light, which then excites each color phosphor layer, thereby emitting red, green, and blue lights.

[Patent literature 1] Japanese Patent Unexamined Publication No. 2007-48733

### SUMMARY OF THE INVENTION

A method of manufacturing plasma display panels is as the following. That is, a plasma display panel includes: a front panel having a dielectric layer formed so as to cover a display electrode, which is formed on a substrate and a protective layer formed on the dielectric layer; and a back panel arranged facing the front panel so as to form a discharge space, having an address electrode formed in a direction crossing the display electrode, and including a barrier rib partitioning the discharge space. The method comprises: depositing a base film on the dielectric layer; applying a crystalline particle paste produced by dispersing crystalline particles made of metal oxide into a solvent to form a crystalline particle paste film; heating the crystalline particle paste film; and removing the solvent to make the plurality of crystalline particles adhere so as to be distributed over a whole surface of the protective layer, wherein the crystalline particle paste has a viscosity between 1 Pa·s and 30 Pa·s inclusive at a shear velocity of 1.0 s⁻¹.

### BRIEF DESCRIPTION OF DRAWINGS

FIG. 1 is a perspective view showing the structure of a PDP according to an embodiment of the present invention.

FIG. 2 is a sectional view showing the structure of the front panel of the PDP according to the embodiment of the present invention.

FIG. 3 is an explanatory diagram showing the protective layer enlarged, of the PDP according to the embodiment of the present invention.

FIG. 4 is an enlarged view for illustrating agglomerated particles in the protective layer of the PDP according to the embodiment of the present invention.

FIG. 5 is a characteristic diagram showing results of measuring cathode luminescence of the crystalline particles.

FIG. 6 is a characteristic diagram showing results of examining the electron emission characteristic and the Vscn lighting voltage in the result of the experiment made to describe advantages according to the present invention.

FIG. 7 is a characteristic diagram showing relationship between the particle diameter of crystalline particles and the electron emission characteristic.

FIG. 8 is a characteristic diagram showing relationship between the particle diameter of crystalline particles and the rate of occurrence of barrier rib breakage.

FIG. 9 is a characteristic diagram showing an example of particle size distribution of agglomerated particles in a PDP according to the present invention.

FIG. 10 is a process chart showing a process of forming a protective layer in the method of manufacturing PDPs according to the present invention.

### REFERENCE MARKS IN THE DRAWINGS

1 PDP
2 Front panel
3 Front glass substrate
4 Scan electrode
4a, 5a Transparent electrode
4b, 5b Metal bus electrode
5 Sustain electrode
6 Display electrode
7 Black stripe (light blocking layer)
8 Dielectric layer
9 Protective layer
10 Back panel
11 Back glass substrate
12 Address electrode
13 Base dielectric layer
14 Barrier rib
15 Phosphor layer
16 Discharge space
81 First dielectric layer
82 Second dielectric layer
91 Base film
92 Agglomerated particle
92a Crystalline particle

### DETAILED DESCRIPTION OF PREFERRED EMBODIMENT

In a PDP, the protective layer formed on the dielectric layer of the front panel has functions such as protecting the dielectric layer from ion bombardment due to discharge, and emitting initial electrons for producing address discharge. Protecting the dielectric layer from ion bombardment is an important role of preventing a rise in discharge voltage. Emitting initial electrons for producing address discharge is an important role of preventing an address discharge error causing image flicker.

To increase the number of initial electrons emitted from the protective layer to reduce image flicker, an attempt to add Si and Al to MgO for example is made.

In recent years, television has been moving to finer-resolution, and thus the market is demanding full-spec high-definition (1920×1080 pixels: progressive scan) PDPs with low cost, low power consumption, and high brightness. The characteristic of electron emission from a protective layer determines the image quality of the PDP, and thus regulating the electron emission characteristic is extremely important.

In view of such a problem, the present invention is made to implement a PDP with high resolution, high brightness, and low power consumption.

Hereinafter, a description is made of a PDP according to an embodiment of the present invention using the related drawings.

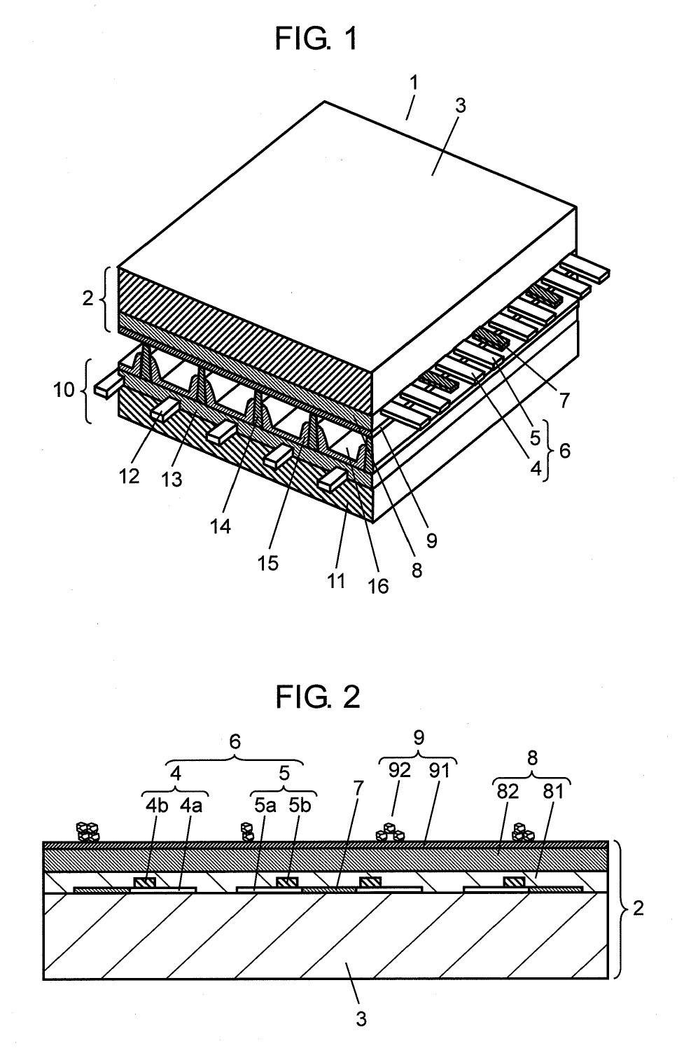

FIG. 1 is a perspective view showing the structure of a PDP according to the embodiment of the present invention. The basic structure of the PDP is the same as that of a typical AC surface-discharge PDP. As shown in FIG. 1, PDP 1 has front panel 2 composed of front glass substrate 3 and other components; and back panel 10 composed of back glass substrate 11 and other components, arranged facing each other, and their outer circumferences are hermetic-sealed with a sealant made of such as glass frit. Discharge space 16 inside PDP 1 sealed has a discharge gas such as Ne and Xe encapsulated thereinto at a pressure of 400 to 600 Torr.

Front glass substrate 3 of front panel 2 has a pair of strip-shaped display electrodes 6 composed of scan electrode 4 and sustain electrode 5; and black stripes (light blocking layer) 7 arranged thereon, parallel to each other in plural lines respectively. Front glass substrate 3 has dielectric layer 8 formed thereon functioning as a capacitor so as to cover display electrodes 6 and light blocking layer 7, and the surface of dielectric layer 8 has protective layer 9 formed thereon composed of such as magnesium oxide (MgO).

Back glass substrate 11 of back panel 10 has plural strip-shaped address electrodes 12 arranged thereon parallel to each other, orthogonally to scan electrodes 4 and sustain electrodes 5 on front panel 2, and base dielectric layer 13 covers address electrodes 12. Further, base dielectric layer 13 between address electrodes 12 has barrier ribs 14 formed thereon with a given height partitioning discharge space 16. The grooves between barrier ribs 14 have phosphor layers 15 emitting red, green, or blue light by ultraviolet light formed therein by being applied sequentially for each address electrode 12. At a position where scan electrode 4 and sustain electrode 5 cross address electrode 12, a discharge cell is formed including phosphor layers 15 for red, green, and blue colors arranged in the direction of display electrodes 6, becoming pixels for color display.

FIG. 2 is a sectional view showing the structure of front panel 2 of PDP 1 according to the embodiment of the present invention, and FIG. 2 represents FIG. 1 vertically inverted. As shown in FIG. 2, front glass substrate 3 produced such as by float process has display electrodes 6 composed of scan electrodes 4 and sustain electrodes 5; and light blocking layer 7, pattern-formed thereon. Scan electrode 4 and sustain electrode 5 are composed of transparent electrodes 4a, 5a made of such as indium tin oxide (ITO) or tin oxide (SnO₂); and metal bus electrodes 4b, 5b formed on transparent electrodes 4a, 5a. Metal bus electrodes 4b, 5b are used to impart electrical conductivity in the longitudinal direction of transparent electrodes 4a, 5a, made of a conductive material primarily containing a silver (Ag) material.

Dielectric layer 8 is structured with at least two layers: first dielectric layer 81 provided so as to cover these transparent electrodes 4a, 5a, metal bus electrodes 4b, 5b, and light blocking layer 7, formed on front glass substrate 3; and second dielectric layer 82 formed on first dielectric layer 81. Further, second dielectric layer 82 has protective layer 9 formed thereon. Protective layer 9 is composed of base film 91 formed on dielectric layer 8 and agglomerated particles 92 adhering onto base film 91.

Next, a description is made of a method of manufacturing PDPs. First, scan electrodes 4, sustain electrodes 5, and light blocking layer 7 are formed on front glass substrate 3. These transparent electrodes 4a, 5a and metal bus electrodes 4b, 5b are formed by patterning such as by photolithography. Transparent electrodes 4a, 5a are formed such as by thin film process, and metal bus electrodes 4b, 5b are solidified by firing a paste containing a silver (Ag) material at a given temperature. Light blocking layer 7 is formed similarly. That is, a glass substrate is screen-printed with a paste containing black pigment, or black pigment is formed on the whole surface of a glass substrate. After that, the glass substrate is patterned by photolithography and then fired.

Next, a dielectric paste is applied onto front glass substrate 3 such as by die coating so as to cover scan electrodes 4, sustain electrodes 5, and light blocking layer 7, to form a dielectric paste layer (dielectric material layer). After the dielectric paste is applied, being left standing for a given time levels the surface of the dielectric paste applied to be flat. After that, the dielectric paste layer is fired and solidified to form dielectric layer 8 covering scan electrodes 4, sustain electrodes 5, and light blocking layer 7. Here, the dielectric paste is a coating material containing a dielectric material (e.g. glass powder), binder, and solvent. Next, protective layer 9 made of magnesium oxide (MgO) is formed on dielectric layer 8 by vacuum deposition. The above-described steps form predetermined components (scan electrode 4, sustain electrode 5, light blocking layer 7, dielectric layer 8, and protective layer 9) on front glass substrate 3 to complete front panel 2.

Meanwhile, back panel 10 is formed in the next way. First, a metal film is formed on the whole surface of back glass substrate 11 such as by screen-printing a paste containing a silver (Ag) material. After that, a material layer becoming a component for address electrode 12 is formed such as by patterning using photolithography. Then, the material layer is fired at a given temperature to form address electrode 12. Next, a dielectric paste is applied onto back glass substrate 11 with address electrodes 12 formed thereon such as by die coating so as to cover address electrodes 12 to form a dielectric paste layer. After that, the dielectric paste layer is fired to form base dielectric layer 13. Here, the dielectric paste is a coating material containing a dielectric material (e.g. glass powder), binder, and solvent.

Next, a barrier-rib-forming paste containing a barrier rib material is applied onto base dielectric layer 13 and patterned into a given shape to form a barrier rib material layer. After that, the barrier rib material layer is fired to form barrier rib 14. Here, methods of patterning the barrier-rib-forming paste applied onto base dielectric layer 13 include photolithography and sandblasting. Next, a phosphor paste containing a phosphor material is applied onto base dielectric layer 13 between adjacent barrier ribs 14 and onto the side of barrier ribs 14, and fired to form phosphor layer 15. The above-described steps complete back panel 10 including prescribed components on back glass substrate 11.

In this way, front panel 2 and back panel 10 including given components are arranged facing each other so that scan electrodes 4 are orthogonal to address electrodes; their peripheries are sealed with glass frit; and a discharge gas containing such as Ne and Xe is encapsulated into discharge space 16 to complete PDP 1.

Here, a detailed description is made of first dielectric layer 81 and second dielectric layer 82 composing dielectric layer 8 of front panel 2. The dielectric material of first dielectric layer 81 is composed of the following materials: bismuth oxide (Bi₂O₃) of 20 wt % to 40 wt %; at least one of calcium oxide (CaO), strontium oxide (SrO), and barium oxide (BaO) of 0.5 wt % to 12 wt %; at least one of molybdenum oxide (MoO₃), tungsten oxide (WO₃), cerium oxide (CeO₂), and manganese dioxide (MnO₂) of 0.1 wt % to 7 wt %.

Instead of molybdenum oxide (MoO₃), tungsten oxide (WO₃), cerium oxide (CeO₂), and manganese dioxide (MnO₂), at least one of copper oxide (CuO), chromium oxide (Cr₂O₃), cobalt oxide (CO₂O₃), vanadium oxide (V₂O₇), and antimony oxide (Sb₂O₃) of 0.1 wt % to 7 wt % may be contained.

As a component other than the above described ones, lead-free materials may be contained such as zinc oxide (ZnO) of 0 wt % to 40 wt %, boron oxide (B₂O₃) of 0 wt % to 35 wt %, silicon oxide (SiO₂) of 0 wt % to 15 wt %, or aluminium oxide (Al₂O₃) of 0 wt % to 10 wt %, where the contained amount of these materials is not particularly limited.

The dielectric material composed of these components is crushed into particles with an average particle diameter of 0.5 to 2.5 μm by a wet jet mill or ball mill to produce dielectric material powder. Next, the dielectric material powder of 55 wt % to 70 wt % and a binder component of 30 wt % to 45 wt % are adequately kneaded by a triple roll mill to produce a paste for the first dielectric layer for die coating or printing.

The binder component is terpineol or butyl carbitol acetate containing ethyl cellulose or acrylic resin of 1 wt % to 20 wt %. In the paste for the first dielectric layer, at least one of di-octyl phthalate, di-butyl phthalate, triphenyl phosphate, and tributyl phosphate may be added as a plasticizer; and at least one of glycerol monooleate, sorbitan sesquioleate, Homogenol (a product name of Kao Corporation), and an alkylallyl phoshate, may be added as required to improve print quality.

Next, this paste for the first dielectric layer is printed onto front glass substrate 3 so as to cover display electrode 6 by die coating or screen printing and dried, followed by being fired at 575 to 590° C., slightly higher than the softening point of the dielectric material.

Next, a description is made of second dielectric layer 82. The dielectric material of second dielectric layer 82 is composed of the following materials: bismuth oxide (Bi₂O₃) of 11 wt % to 20 wt %; at least one of calcium oxide (CaO), strontium oxide (SrO), and barium oxide (BaO) of 1.6 wt % to 21 wt %; at least one of molybdenum oxide (MoO₃), tungsten oxide (WO₃), and cerium oxide (CeO₂) of 0.1 wt % to 7 wt %.

Instead of molybdenum oxide (MoO₃), tungsten oxide (WO₃), and cerium oxide (CeO₂), at least one of copper oxide (CuO), chromium oxide (Cr₂O₃), cobalt oxide (CO₂O₃), vanadium oxide (V₂O₇), antimony oxide (Sb₂O₃), and manganese oxide (MnO₂) of 0.1 wt % to 7 wt % may be contained.

As a component other than the above described ones, lead-free materials may be contained such as zinc oxide (ZnO) of 0 wt % to 40 wt %, boron oxide (B₂O₃) of 0 wt % to 35 wt %, silicon oxide (SiO₂) of 0 wt % to 15 wt %, or aluminium oxide (Al₂O₃) of 0 wt % to 10 wt %, where the contained amount of these materials is not particularly limited.

The dielectric material composed of these components is crushed into particles with an average particle diameter of 0.5 to 2.5 μm by a wet jet mill or ball mill to produce dielectric material powder. Next, the dielectric material powder of 55 wt % to 70 wt % and a binder component of 30 wt % to 45 wt % are adequately kneaded by a triple roll mill to produce a paste for the second dielectric layer for die coating or printing. The binder component is terpineol or butyl carbitol acetate containing ethyl cellulose or acrylic resin of 1 wt % to 20 wt %. In the paste for the second dielectric layer, di-octyl phthalate, di-butyl phthalate, triphenyl phosphate, and tributyl phosphate may be added as a plasticizer; and such as glycerol monooleate, sorbitan sesquioleate, Homogenol (a product name of Kao Corporation), and an alkylallyl phoshate, may be added as required to improve print quality.

Next, this paste for the second dielectric layer is printed onto first dielectric layer 81 by die coating or screen printing and dried, followed by being fired at 550 to 590° C., slightly higher than the softening point of the dielectric material.

The film thickness of dielectric layer 8 is preferably less than 41 μm including first dielectric layer 81 and second dielectric layer 82 to ensure a certain level of visible light transmittance. First dielectric layer 81 is made contain bismuth oxide (Bi₂O₃) 20 to 40 wt %, more than second dielectric layer 82 does, to restrain the reaction of metal bus electrodes 4b, 5b with silver (Ag). Consequently, the visible light transmittance of first dielectric layer 81 is lower than that of second dielectric layer 82, and thus the film thickness of first dielectric layer 81 is made thinner than that of second dielectric layer 82.

Second dielectric layer 82 containing less than 11 wt % bismuth oxide (Bi₂O₃) is resistant to being colored, but bubbles unpreferably tend to occur in second dielectric layer 82. Meanwhile, first dielectric layer 81 containing more than 40 wt % bismuth oxide (Bi₂O₃) tends to cause coloring, which is unpreferable for the purpose of raising transmittance.

The less the film thickness of dielectric layer 8 is, the more prominently the panel brightness is increased and the discharge voltage is decreased, and thus the film thickness is desirably set to the smallest possible value as long as the dielectric withstand voltage remains not to be decreased. From such a viewpoint, the film thickness of dielectric layer 8 is set to less than 41 μm; first dielectric layer 81, 5 to 15 m; and second dielectric layer 82, 20 to 36 μm.

With a PDP produced in this way, front glass substrate 3 hardly exhibits a coloration phenomenon (yellowing) and bubbles are not generated in dielectric layer 8 even if a silver (Ag) material is used for display electrode 6. Accordingly, dielectric layer 8 superior in withstand voltage performance can be implemented.

Next, in a PDP according to the embodiment of the present invention, an investigation is made of the reason why yellowing and bubble generation are restrained in first dielectric layer 81 by these dielectric materials. It is known that a compound such as Ag₂MoO₄, Ag₂Mo₂O₇, Ag₂Mo₄O₁₃, Ag₂WO₄, Ag₂W₂O₇, and Ag₂W₄O₁₃ is easily generated at a low temperature below 580° C. by adding molybdenum oxide (MoO₃) or tungsten oxide (WO₃) into dielectric glass containing bismuth oxide (Bi₂O₃). In the embodiment of the present invention, since the firing temperature of dielectric layer 8 is 550 to 590° C., silver ions (Ag⁺) diffused into dielectric layer 8 while firing react with molybdenum oxide (MoO₃), tungsten oxide (WO₃), cerium oxide (CeO₂), and manganese oxide (MnO₂) in dielectric layer 8 to generate a stable compound, resulting in being stabilized. In other words, silver ions (Ag⁺) are stabilized without being reduced, and thus they do not agglutinate to generate colloids. Hence, stabilization of silver ions (Ag⁺) decreases the amount of oxygen generated due to colloidization of silver (Ag), and so do bubbles generated in dielectric layer 8.

Meanwhile, in order to make these advantages effective, dielectric glass containing bismuth oxide (Bi₂O₃) preferably contains molybdenum oxide (MoO₃), tungsten oxide (WO₃), cerium oxide (CeO₂), and manganese oxide (MnO₂) more than 0.1 wt %, more preferably between 0.1 wt % and 7 wt %. Particularly, at less than 0.1 wt %, yellowing is hardly restrained, and at more than 7 wt %, the glass unpreferably exhibits coloring.

More specifically, dielectric layer 8 of a PDP according to the embodiment of the present invention restrains a yellowing phenomenon and bubble generation at first dielectric layer 81 contacting metal bus electrodes 4b, 5b made of a silver (Ag) material. Dielectric layer 8 implements high light transmittance by means of second dielectric layer 82 provided on first dielectric layer 81. Consequently, bubbles and yellowing occur to a minimal extent in dielectric layer 8 as a whole, thereby implementing a PDP with high transmittance.

Next, a description is made of the structure and a method of producing a protective layer, which is a feature of a PDP according to the embodiment of the present invention.

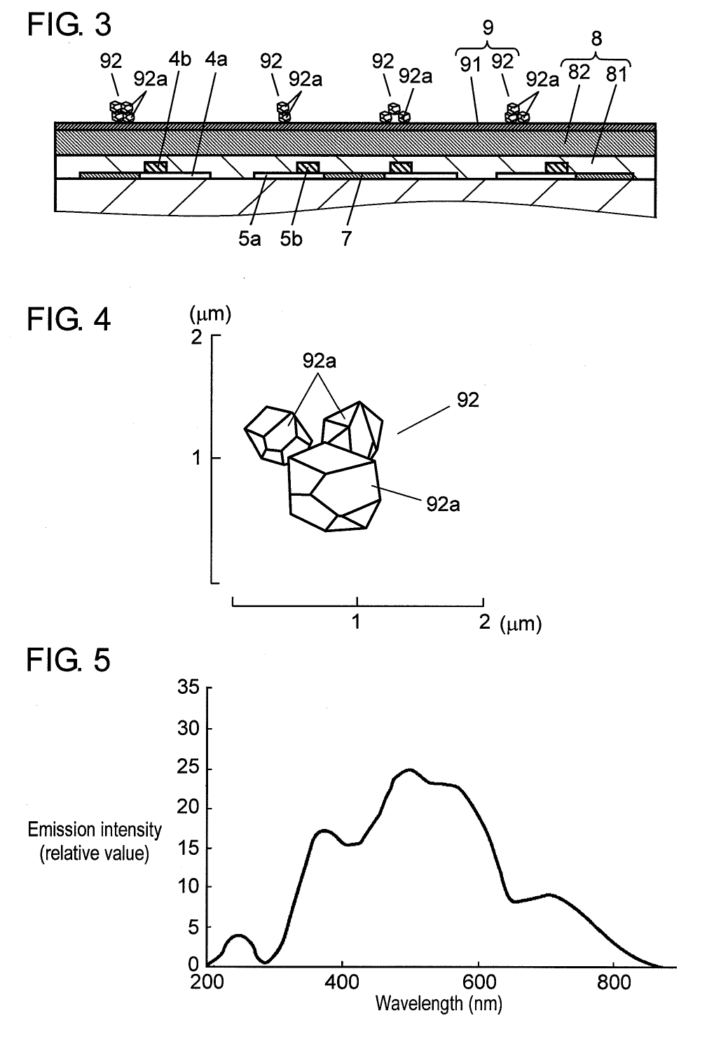

As shown in FIG. 3, in a PDP according to the embodiment of the present invention, protective layer 9 is produced in the following way. That is, base film 91 made of MgO containing Al as an impurity is formed on dielectric layer 8. Further, agglomerated particles 92 each of which is composed of several pieces of crystalline particles 92a of MgO (i.e. metal oxide) aggregated are sprayed on the base film 91 discretely to make agglomerated particles 92 adhere so as to be distributed roughly uniformly over the whole surface.

Here, agglomerated particle 92 is in a state where crystalline particles 92a with a given primary particle diameter aggregating or necking as shown in FIG. 4. They do not bond with one another with a strong bonding force as solid, but plural primary particles are in a form of an aggregate by static electricity, van der Waals forces, or other forces, where part or all of these are bonded at the extent to which they become primary particles by an external stimulus such as an ultrasonic wave. Desirably, the particle diameter of agglomerated particles 92 is approximately 1 μm, and crystalline particle 92a has a polyhedral shape with seven or more sides.

The particle diameter of primary particles of these MgO crystalline particles 92a can be regulated by conditions of forming crystalline particles 92a. For example, when generating crystalline particles 92a by firing an MgO precursor such as magnesium carbonate and magnesium hydroxide, regulating firing temperature and firing atmosphere allows the particle diameter to be regulated. Setting firing temperature (selectable typically between approximately 700 and 1,500° C.) to 1,000° C. or higher (relatively high) allows the primary particle diameter to be regulated to between approximately 0.3 and 2 μm. In addition, producing crystalline particles 92a by heating an MgO precursor yields agglomerated particles 92 produced from plural primary particles bonded with one another by aggregation or necking in the forming process.

Next, a description is made of results of an experiment made to verify the effects of a PDP having a protective layer according to the embodiment of the present invention.

First, some PDPs having protective layers with different structures are produced experimentally. Trial piece 1 is a PDP with only a protective layer formed made of MgO. Trial piece 2 is a PDP with a protective layer formed made of MgO into which an impurity such as Al and Si is doped. Trial piece 3 is a PDP produced by spraying only the primary particles of crystalline particles made of metal oxide onto base film 91 made of MgO to make adhere. Trial piece 4 is a PDP of the present invention, produced in the following way. That is, as described above, a crystalline particle paste made of agglomerated particles and a dispersive solvent are applied onto a base film made of MgO to form a crystalline particle paste film. After that, the base film and crystalline particle paste film are fired to make agglomerated particles produced by aggregating the crystalline particles adhere so as to be distributed over the whole surface roughly uniformly. The agglomerated particles are plural crystalline particles made of metal oxide aggregated. The dispersion solvent disperses the agglomerated particles and is classified into either aliphatic alcohol solvent with ether linkage or a divalent or higher-valent alcohol solvent. In trial pieces 3, 4, monocrystalline particles of MgO are used as the metal oxide. The cathode luminescence measured for the crystalline particles used in trial piece 4 according to the exemplary embodiment has the characteristic of an emission intensity to the wavelengths shown in FIG. 5, where the emission intensity is represented by a relative value.

The electron emission characteristic and charge retention characteristic are examined for PDPs with four types of protective layers.

The electron emission characteristic is a numeric value showing that the larger it is, the larger the amount of electron emission is, represented by the amount of initial electron emission determined by a condition of the discharge surface; and the type and a condition of the gas. The amount of initial electron emission can be determined by irradiating the surface with ions or electron beams to measure the current of electrons emitted from the surface. However, nondestructively evaluating the front surface of the panel is difficult. Under the circumstances, as described in Japanese Patent Unexamined Publication No. 2007-48733, a numeric value is measured giving an index of the possibility of discharge called statistical delay time out of delay time when discharging. Then, the reciprocal of the numeric value is integrated to calculate a numeric value linearly corresponding to the amount of initial electron emission. For this reason, this numeric value calculated is used here to evaluate the amount of electrons emitted. The delay time when discharging means the time from the rising edge of the pulse to the time when discharge is executed with a delay. Discharge delay is considered to be caused primarily by the fact that initial electrons triggering discharge is less likely to be emitted from the surface of a protective layer into a discharge space.

The charge retention characteristic, as its index, is a value of voltage (referred to as a Vscn lighting voltage hereinafter) applied to a scan electrode, required to suppress charge emission when produced as a PDP. That is, the value indicates that a PDP with a lower Vscn lighting voltage has a higher charge retention characteristic. This enables a PDP to be driven with a low voltage, allowing parts with lower withstand voltage and capacitance to be used for the power supply unit and electric components in designing a PDP panel. In a current product, an element with a withstand voltage of approximately 150 V is used for a semiconductor switching element such as a MOSFET for applying a scan voltage sequentially to the panel. For this reason, the Vscn lighting voltage is desirably below 120 V in consideration of fluctuation due to temperature.

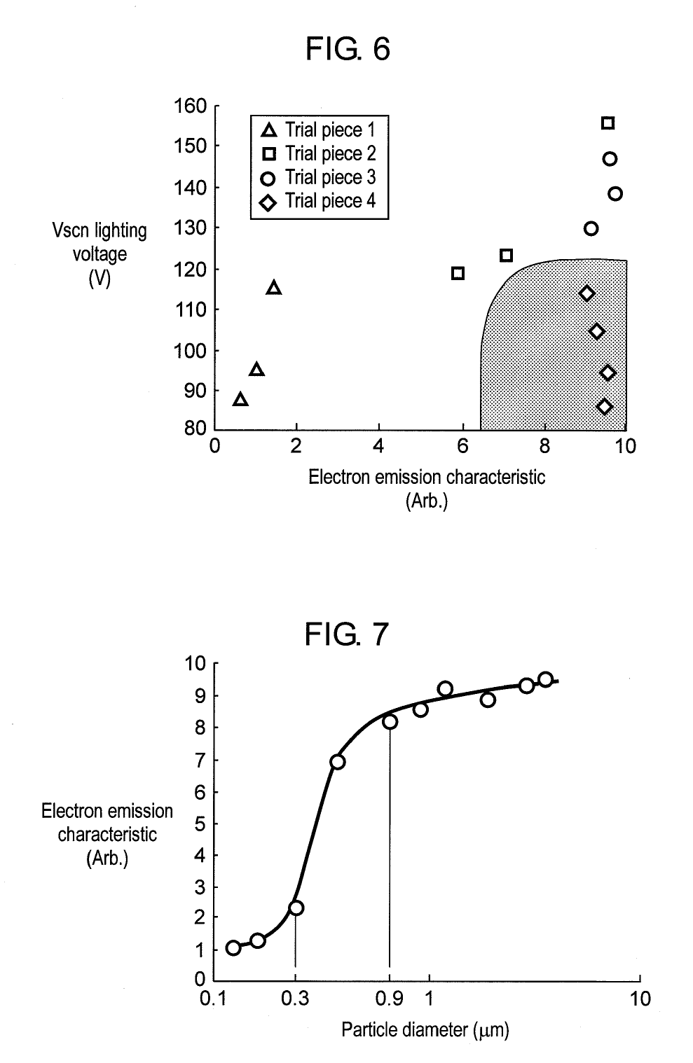

FIG. 6 shows results of examining these electron emission characteristic and charge retention characteristic. As evidenced by FIG. 6, in trial piece 4, voltage Vscn can be made below 120 V in evaluating the charge retention characteristic, and the electron emission characteristic represents a favorable characteristic of 6 or higher.

In other words, in the protective layer of a PDP, the electron emission characteristic is typically contradictory to the charge retention characteristic. For example, changing the film-forming condition of a protective layer and forming a film with an impurity such as Al, Si, and Ba doped into a protective layer allow improving the electron emission characteristic, while increasing Vscn lighting voltage as a side effect

In a PDP with protective layer 9 according to the embodiment of the present invention formed, a PDP is available that has an electron emission characteristic of 6 or higher and a charge retention characteristic of 120 V or lower (Vscn lighting voltage). In this way, for the protective layer of a PDP in which the number of scanning lines tends to increase by moving to finer resolution while decreasing the cell size, both electron emission characteristic and charge retention characteristic can be satisfied.

Next, a description is made of the particle diameter of crystalline particles used for protective layer 9 of a PDP according to the embodiment of the present invention. In the following description, a particle diameter refers to an average particle diameter, which means an average cubic cumulative diameter (D50).

FIG. 7 shows results of an experiment for examining the electron emission characteristic with the particle diameter of MgO crystalline particles changed in trial piece 4 of the present invention described in FIG. 6 above. In FIG. 7, the particle diameter of MgO crystalline particles is measured by observing the crystalline particles with an SEM.

FIG. 7 proves that a particle diameter as small as approximately 0.3 μm causes the electron emission characteristic to decrease; roughly 0.9 μm or larger brings about a high electron emission characteristic.

Meanwhile, to increase the number of electrons emitted in a discharge cell, more crystalline particles 92a per a unit area of base film 91 is desirable. According to an experiment by the inventors, presence of crystalline particles 92a at back panel 10 closely contacting protective layer 9 of front panel 2 can break the top of barrier rib 14. When the broken material is positioned on phosphor layer 15, for example, the corresponding cell is found to cease to be lit on and off normally. This barrier rib breakage is unlikely to occur unless crystalline particles are present at a part corresponding to the top of a barrier rib, and thus as the number of crystalline particles made adhere increases, the probability of occurrence of barrier rib breakage increases.

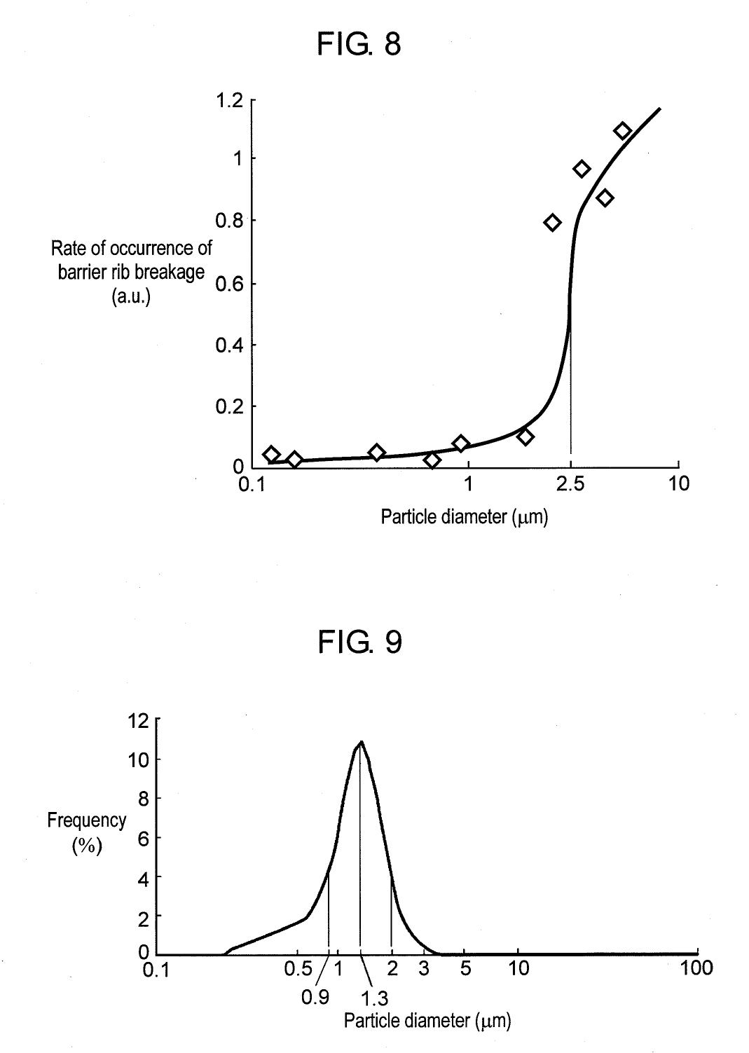

FIG. 8 shows results of an experiment where, in trial piece 4 of the embodiment of the present invention described in FIG. 6 above, the same number (per unit area) of crystalline particles with different particle diameters are sprayed onto base film 91, and the relationship between a particle diameter and occurrence of barrier rib breakage is examined.

As evidenced by FIG. 8, a crystalline particle diameter of approximately 2.5 μm sharply increases the probability of barrier rib breakage, while that smaller than 2.5 μm can suppress the probability to a relatively small extent.

Based on the above-described results, for a protective layer of a PDP of the embodiment of the present invention, the particle diameter of crystalline particles 92a is desirably between 0.9 and 2.5 μm. When actually mass-producing PDPs, variations in manufacturing crystalline particles 92a and protective layers 9 need to be considered.

To consider factors such as variations in manufacturing, an experiment is made with the particle diameter of crystalline particles changed. FIG. 9 shows relationship between a particle diameter of a crystalline particle and the frequency of the presence of crystalline particles having the particle diameter as an example. In the example of crystalline particles shown in FIG. 9, crystalline particles with an average particle diameter between 0.9 and 2 μm are found to stably present the above-described effects of the present invention.

As described above, a PDP with a protective layer according to the present invention formed presents an electron emission characteristic of 6 or higher and a charge retention characteristic of 120 V or lower (Vscn lighting voltage). Hence, for the protective layer of a PDP in which the number of scanning lines tends to increase by moving to finer resolution while decreasing the cell size, both electron emission characteristic and charge retention characteristic can be satisfied. Herewith, a PDP can be implemented with display performance of high resolution and high brightness, and low power consumption.

In a PDP according to the present invention, a protective layer can be formed in the following method. That is, after a base film is deposited onto a dielectric layer, a crystalline particle paste produced by dispersing plural crystalline particles made of metal oxide in a solvent is applied to the base film to form a crystalline particle paste film. After that, the paste film is heated to remove the solvent, thereby making crystalline particles adhere.

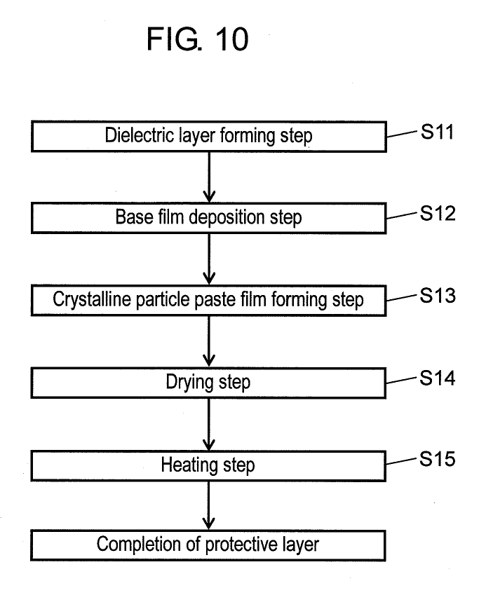

As shown in FIG. 10, dielectric layer forming step S11 is performed in which dielectric layer 8 composed of first dielectric layer 81 and second dielectric layer 82 laminated are formed. After that, in the next base film deposition step S12, a base film made of MgO is formed on second dielectric layer 82 of dielectric layer 8 by vacuum deposition with a sintered body of MgO containing Al as raw material.

After that, crystalline particle paste film forming step S13 is performed in which plural crystalline particles are made discretely adhere onto the unfired base film formed in base film deposition step S12.

In this step, the following crystalline particle paste is first prepared. That is, agglomerated particles 92 with a given distribution of particle diameters are mixed together with a resin component into a dispersive solvent as a single or mixed solvent, where the dispersive solvent is classified into either aliphatic alcohol solvent with ether linkage (e.g. ethylene glycol, diethylene glycol, propylene glycol, glycerine, diethylene glycol monobutyl ether, diethylene glycol diethyl ether, diethylene glycol monobutyl ether acetate, 3-methoxy-3-methyl-1-butanol, benzyl alcohol, terpineol) or a divalent or higher-valent alcohol solvent. In crystalline particle paste film forming step S13, the crystalline particle paste is applied onto an unfired base film by printing such as screen printing to form a crystalline particle paste film.

Methods of applying a crystalline particle paste onto an unfired base film to form a crystalline particle paste film include spraying, spin coating, die coating, and slit coating, besides screen printing.

After this crystalline particle paste film is formed, it is dried in drying step S14.

After that, the unfired base film formed in base film deposition step S12, and the crystalline particle paste film formed in crystalline particle paste film forming step S13 and dried in drying step S14 are heated at a temperature of several hundred degrees centigrade in heating step S15. Simultaneously, firing is performed to remove the solvent and resin component remaining in the crystalline particle paste film, thereby forming protective layer 9 with plural agglomerated particles 92 adhering onto base film 91.

Here, the resin component may be optionally used as required depending on an applying method, and does not need to be used if a resin component is not always necessary such as in spraying and slit coating.

Meanwhile, in the method of the present invention, a crystalline particle paste containing given crystalline particles is applied by a method of producing a thin or thick film, such as spraying, spin coating, screen printing, die coating, and slit coating. After that, the solvent component is removed by a heating method such as drying or firing to make the crystalline particles adhere so as to be distributed uniformly. Meanwhile, whether drying or firing is determined by a solvent as the solvent component of the paste. More specifically, if the solvent component is made of a solvent with low volatilization temperature, such as ethanol, the solvent component can be volatilized and removed by a drying process at approximately 80 to 120° C. However, if the solvent contains a component with relatively high volatilization temperature such as terpineol and ethyl cellulosic or a component with low vapor pressure, undergoing a firing step at a highest temperature of approximately 250 to 500° C. is required.

When forming a film by screen printing, the film thickness can be regulated such as by the pitch of the screen mesh. Meanwhile, from the aspect of unevenness in the mesh surface, a too thin film increases unevenness. Forming a film with the particle density made thin and with the film thickness made thick tend to increase unevenness in the distribution of the particles in the paste. Further, viscosity determines the settling velocity of the particles in the paste, where a higher viscosity decreases the settling velocity, and thus stable manufacturing is expected. However, to make the distribution of the particles in the paste uniform, agitation such as by a triple roller is made for a long time, thus extremely decreasing the efficiency in paste manufacturing.

When printing a large area like a PDP uniformly by screen printing, various past results prove that a film thickness of some 10 μm allows manufacturing most stably. Consequently, with the central target of the film thickness being 10 μm and with the surrounding environment considered, the paste is applied in a favorable distribution in the viscosity range between 20 and 30 Pa·s at a shear velocity of 1.0 s⁻¹. Meanwhile, with the maximum particle diameter (assumed to be settled to the largest extent), a viscosity of 1 Pa·s or higher allows stable use for sufficient time. As a result, spraying by printing can be executed without problems in the viscosity range between 20 and 30 Pa·s at a shear velocity of 1.0 s⁻¹.

Meanwhile, by a coater such as a die coater and slit coater, a film can be formed even with a paste containing a solvent with relatively low viscosity and low evaporating temperature. However, low viscosity makes particles be settled at an extremely high speed, thus requiring the viscosity and particle diameter to be adjusted for stable manufacturing. As a result, to maintain the surface distribution of particles at the finish level roughly the same as that by printing described above, variation due to settling needs to be less than that by printing. However, the paste viscosity needs to be 30 Pa·s or lower allowing for the maximum particle diameter. Meanwhile, for the minimum particle diameter, it is adequate if the paste viscosity is 1 Pa·s or higher allowing for a several-day pot life.

In the above description, MgO is used as an example of protective layer 9. However, performance required for a base is absolutely high anti-sputtering property for protecting a dielectric substance from ion bombardment, and thus very high charge retention characteristic (i.e. electron emission characteristic) is not required. In a conventional PDP, to achieve a balance between electron emission characteristic and anti-sputtering property at a certain level, protective layer 9 primarily contains MgO very typically. However, the electron emission characteristic is predominantly regulated by metal oxide monocrystalline particles, and thus there is no reason for using MgO, but another material with high impact resistance such as Al₂O₃ may be used.

In the exemplary embodiment of the present invention, the description is made using MgO particles as monocrystalline particles 92a. However, other monocrystalline particles of metal (e.g. Sr, Ca, Ba, Al) oxide having high electron emission characteristic similarly to MgO present the same effect. For this reason, the type of monocrystalline particles is not limited to MgO.

In a conventional PDP, an attempt is made to improve electron emission characteristic by mixing impurities in the protective layer. However, when mixing impurities in the protective layer to improve electron emission characteristic, electric charge is accumulated on the surface of the protective layer and the attenuation rate with which electric charge used as a memory function decreases with time increases. As a result, measures such as increasing applied voltage for preventing the problem are needed. A protective layer thus needs to have two mutually contradictory characteristics: high electron emission characteristic and high charge retention characteristic (i.e. low attenuation rate of electric charge for a memory function).

However, as proved by the above description, the present invention provides a PDP that has improved electron emission characteristic together with charge retention characteristic to balance high image quality, low cost, and low voltage. Herewith, a PDP can be implemented with display performance of high resolution and high brightness, and low power consumption.

Further, according to the manufacturing method of the present invention, plural agglomerated particles can be made adhere so as to be distributed over the whole surface roughly uniformly.

### INDUSTRIAL APPLICABILITY

As described above, the present invention is useful for implementing a PDP with display performance of high resolution and high brightness, and low power consumption.

1. A method of producing a plasma display panel, the plasma display panel including:
a front panel having:
a dielectric layer formed so as to cover a display electrode, which is formed on a substrate and;
a protective layer formed on the dielectric layer; and
a back panel arranged facing the front panel so as to form a discharge space, having an address electrode formed in a direction crossing the display electrode, and including a barrier rib partitioning the discharge space,
the method comprising:
depositing a base film on the dielectric layer;
applying a crystalline particle paste produced by dispersing crystalline particles made of metal oxide into a solvent to form a crystalline particle paste film;
heating the crystalline particle paste film; and
removing the solvent to make the plurality of crystalline particles adhere so as to be distributed over a whole surface of the protective layer,
wherein the crystalline particle paste has a viscosity between 1 Pa·s and 30 Pa·s inclusive at a shear velocity of 1.0 s⁻¹.

2. The method of producing a plasma display panel of claim 1,
wherein an average particle diameter of the crystalline particles is between 0.9 μm and 2 μm inclusive.

3. The method of producing a plasma display panel of claim 1, wherein the base film is made of MgO.
